(19) United States
(12) Patent Application Publication
(10) Pub. No.: US 2017/0059847 A1
(43) Pub. Date: Mar. 2, 2017

(54) VARIABLE MAGNIFICATION DEVICE

(71) Applicant: Do Hyeon LIM, Changwon-si (KR)

(72) Inventor: Do Hyeon LIM, Changwon-si (KR)

(21) Appl. No.: 14/848,163

(22) Filed: Sep. 8, 2015

(30) Foreign Application Priority Data
Aug. 25, 2015 (KR) 10-2015-0119698

(51) Int. Cl. G02B 23/00; G02B 23/16; F41G 1/38; G02B 7/04

(52) U.S. Cl. CPC G02B 23/145; G02B 7/04; G02B 23/16; F41G 1/38

(57) ABSTRACT

The present invention provides an improved variable magnification device. The improved variable magnification device includes: a rotation bunch disposed around the outer side of lens barrel of a telescopic sight and moving a magnification lens mounted in the telescopic sight by turning around the outer side; a clamp unit covering the outer side of the rotation bunch and turning with the rotation bunch; and a handle disposed on the clamp unit and provided as a handle for a user to turn the rotation bunch, in which the clamp unit is detachably coupled to the rotation bunch.

### CROSS-REFERENCE TO RELATED APPLICATION

This application claims the benefit of Korean Application No. 10-3015-0119698, filed on Aug. 25, 2015 with the Korean Intellectual Property Office, the disclosure of which is incorporated herein by reference.

### BACKGROUND OF THE INVENTION

1. Field of the Invention

The present invention relates to an improved variable magnification device, and more particularly, to an improved variable magnification device that makes it easy to adjustment magnification of a telescopic sight and that can be conveniently attached/detached.

2. Description of the Related Art

A telescopic sight, which means a telescope for collimating, is a device that is attached to small arms such as a rifle and enlarges and accurately aims an object at a distance.

Aiming of a rifle is usually made by sight alignment to an object, which is an important step that determines accuracy of shooting, in which a foresight at the end of a barrel and a hindsight at a body are aligned.

However, since the foresight and the hindsight are very small and they become out of alignment, even due to small shaking, a shooter needs intensive concentration, for sight alignment.

However, if a shooter too much cares about sight alignment, the eyes are concentrated on the foresight and the hindsight and the field of view becomes narrow.

Further, sight alignment takes relatively long time against the characteristic of shooting that is supposed to rapidly hit an ensured object.

Accordingly, telescopic sights were attached to rifles in the related art to solve this problem. Such telescopic sights, which are made by adding coordinates or points to the principle of telescopes, allow for aiming an object at a distance by adjusting the magnification from a low level to a high level without specific sight alignment.

Telescopic sights of the related art have a body composed of an objective lens barrel, a central tube, and an eyepiece lens barrel, which are continuous, and an internal assembly equipped with a variable magnification lens is disposed in the central tube.

Herein, the variable magnification lens is moved by a zoom front wheel that is turned around the outer side of central tube, and accordingly, magnification of the telescopic sights is changed.

However, it is difficult to turn the zoom front wheel in an aiming position. This is because it is not easy to find the position of the zoom front wheel only with the sense of touch of a hand in an aiming position with while looking at the inside of the eyepiece lens barrel.

Further, most zoom front wheels are tight not to be freely turned by vibration due to firing of a rifle, so it is difficult to turn the scorn front wheels with one hand.

Accordingly, a shooter has to strongly turn the zoom front wheels with one hand after changing the aiming position with the eyes off the eyepiece lens barrel in order to turn the zoom front wheels.

Further, it is required to finely turn a zoom front wheel for precise focusing, but it is difficult to finely operate a zoom front wheel that is not easily turned by one hand in an aiming position, as described above.

A “Device for variable magnification and telescopic sight using the same” has been disclosed in Korean Patent No. 10-1211133 (Dec. 12, 2012) by the applicant(s) to solve this problem.

According to the device, the problem of the related art was solved by providing a rod, which is bendable in the longitudinal direction of a lens barrel, at a bending end of a rotation bunch and turning a rotation bunch with, the rod held.

However, adjustment of magnification of the telescopic sight can be conveniently performed, but it is difficult to couple the rotation bunch to the lens barrel, so this problem needs to be solved.

### PRIOR ART DOCUMENT

[Patent Document] Korean Patent No. 10-1211133 (LIM Do-Hyun) Dec. 5, 2012.

### SUMMARY OF THE INVENTION

An object of the present invention is to provide an improved variable magnification device that makes it easy to adjust magnification of a telescopic sight and that can be easily attached/detached.

According to an aspect of the present invention, there may be provided an improved variable magnification device that includes: a rotation bunch disposed around the outer side of lens barrel of a telescopic sight and moving a magnification lens mounted in the telescopic sight by turning around the outer side; a clamp unit covering the outer side of the rotation bunch; and a handle disposed on the clamp unit and provided as a handle for a user, in which the clamp unit, is detachably coupled to the rotation bunch.

The clamp unit may include: a first clamp covering a radius of the rotation bunch; a second clamp covering the other radius of the rotation bunch; and a fastening member detachably thread-fastening the first clamp and the second clamp to each other.

At least one insertion protrusion that is inserted in a rotation bunch groove of the rotation bunch may be formed on at least one of the inner side of the first clamp and the inner side of the second clamp.

A handle support arm protruding toward the handle may be formed at the clamp unit, and the handle may have: a handle body having a plurality of support grooves on the outer side and rotatably coupled to the handle support arm; and a fastening pin rotatably coupling the handle body to the handle support arm.

A plurality of visual field holes may be formed in the height direction of the handle body.

According to embodiments of the present invention, the rotation, bunch for moving the magnification lens mounted in the telescopic sight is covered with the clamp unit and the clamp unit is detachably coupled to the rotation bunch, so they can be conveniently coupled and separated.

Further, the handle is mounted on the clamp unit turning integrally with the rotation bunch and a user turns the rotation bunch with a hand holding the handle, so it is possible to conveniently adjust the magnification of the telescopic sight.

### BRIEF DESCRIPTION OF THE DRAWINGS

FIG. 1 is a schematic perspective view illustrating an improved variable magnification device according to an embodiment of the present invention.

FIG. 2 is a rear perspective view illustrating the improved variable magnification device illustrated in FIG. 1.

FIG. 3 is an exploded front view of a clamp unit illustrated in FIG. 1.

FIG. 4 is a view illustrating another embodiment of the clamp unit illustrated in FIG. 3.

FIG. 5 is a view illustrating use of an embodiment.

### DETAILED DESCRIPTION OF THE PREFERRED EMBODIMENTS

It is necessary to refer to the accompanying drawings illustrating preferred embodiments of the present invention and those illustrated in the drawings in order to fully understand the present invention, operational advantages of the present invention, and objects accomplished by implementing the present invention.

The present invention is described hereafter in detail by describing preferred embodiments of the present invention with reference to the accompanying drawings. Like reference numerals indicate like components in the drawings.

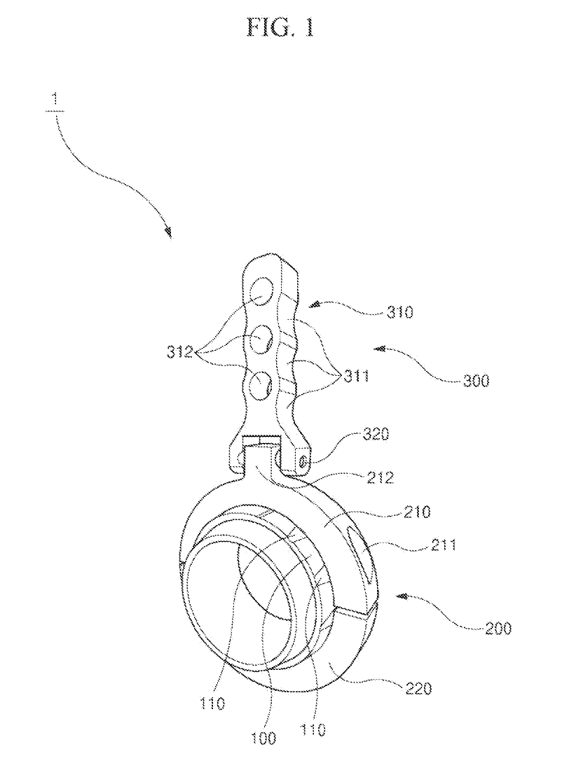

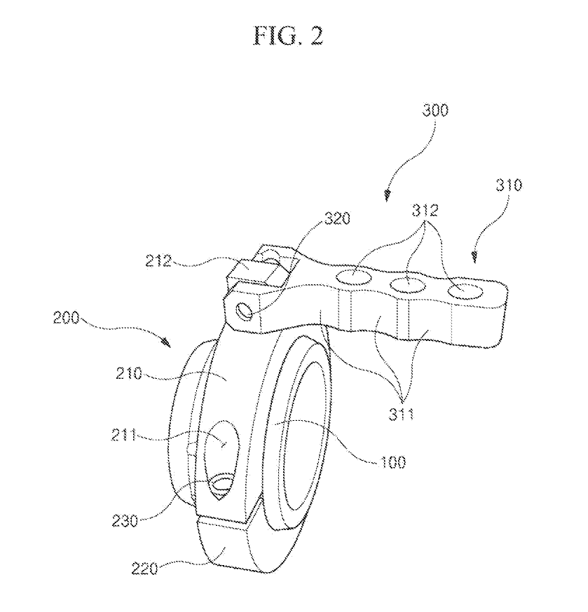

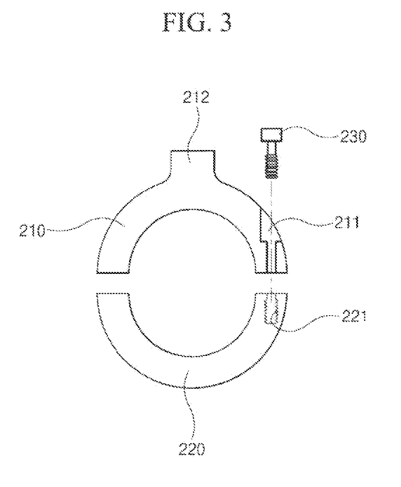

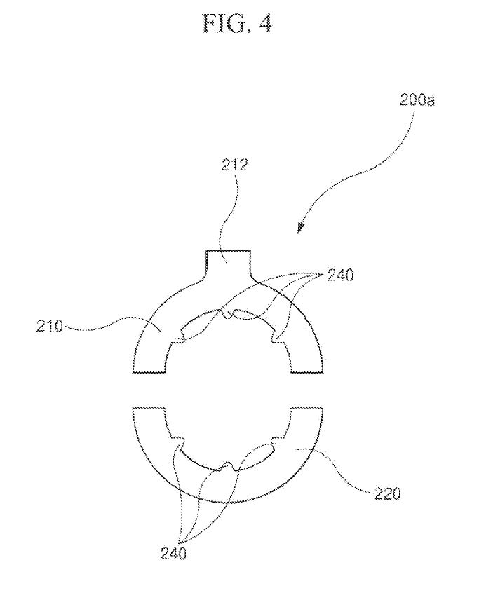

FIG. 1 is a schematic perspective view illustrating an improved variable magnification device according to an embodiment of the present invention. FIG. 2 is a rear perspective view illustrating the improved variable magnification device illustrated in FIG. 1, FIG. 3 is an exploded front view of a clamp unit illustrated in FIG. 1, and FIG. 4 is a view illustrating another embodiment of the clamp unit illustrated in FIG. 3.

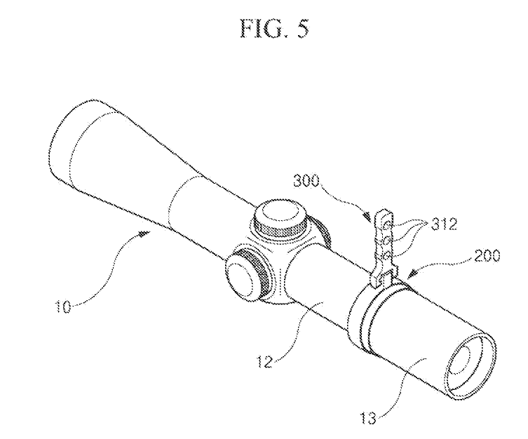

As illustrated in the figures, an improved variable magnification device 1 according to an embodiment includes a rotation bunch 100 disposed around the outer side of a lens barrel 12 (see FIG. 5) of a telescopic sight 10 (see FIG. 5) and moving a magnification lens mounted in the telescopic sight 10 by turning around the outer side of the lens barrel, a clamp unit 200 disposed around the outer-side of rotation bunch 100 and turning with the rotation bunch 100, and a handle 300 disposed on the clamp unit 200 and used as a handle for a user to turn the rotation bunch 100.

The rotation bunch 100 is fitted on the outer side of lens barrel 12 to adjustment of the magnification of the telescopic sight 10, similar to the zoom front wheels of the related art, and horizontally moves the magnification lens mounted in the telescopic sight 10 by turning around the outer side of lens barrel 12.

The rotation bunch or the zoom front wheel disclosed in Korean Patent No. 10-1211133 by the applicant(s) or U.S. Pat. No. 8,625,211B2 may be employed for the rotation bunch 100 of the embodiment.

Further, in this embodiment, the rotation bunch 100 may have a shape corresponding to the lens barrel 12, such as a ring, and a plurality of rotation bunch grooves 110 may be formed at a distance on the outer side of the rotation bunch 100, as illustrated in FIG. 1.

A plurality of insertion protrusions 240 may be inserted and fixed in the rotation bunch grooves 110 in the embodiment, as illustrated in FIG. 4. Accordingly, since the plurality of insertion protrusions 240 are inserted in the rotation bunch grooves 110, it is possible to reduce sliding and idling of the clamp unit 200 with respect to the rotation bunch 100 when a user turning the rotation bunch 100 by turning the clamp unit 200 with a hand holding a handle body 310.

The clamp unit 200, as illustrated in FIGS. 1 and 2, is detachably coupled to the rotation bunch 100 and turns the rotation bunch 100 by transmitting torque from the handle 300 to the rotation bunch 100 as a coupling place of the handle 300.

In the embodiment, the clamp unit 200, as illustrated in FIGS. 2 and 3, includes a first clamp 210 covering a radius of the rotation bunch 100, a second clamp 220 covering the other radius of the rotation bunch 100, and a fastening member 230 detachably thread-fastening the first clamp 210 and the second clamp 220 to each other.

The first clamp 210 of the clamp unit 200, as illustrated in FIG. 1, may have a shape corresponding to the outer shape of the rotation bunch 100. for example, a semi-elliptical shape.

Further, in the embodiment, a fastening hole 211 that is a fastening passage for the fastening member 230 is formed in the first clamp 210, as illustrated in FIGS. 2 and 3.

In addition, in the embodiment, a handle support arm 212 is formed on the outer side of the first clamp 210, as illustrated in FIGS. 1 to 3, and the handle body 310 may be rotatably hinge-coupled to the handle support arm 212.

The second clamp 220 of the clamp unit 200, similar to the first clamp, may have a shape corresponding to the outer shape of the rotation bunch 100, for example, a semi-elliptical shape.

Further, in the embodiment, a fastening groove 221 to which the lower end of the fastening member 230 is thread-fastened is formed in the second clamp 220, as illustrated in FIG. 3. In the embodiment, threads may be formed in the fastening groove 221 to thread-fasten the lower end of the fastening member 230.

The fastening member 230 of the clamp unit 200 is thread-fastened to the fastening groove 221 of the second clamp 220 illustrated in FIG. 3 through the fastening hole 211 of the first clamp 210 illustrated in FIG. 2, thereby coupling the first clamp 210 and the second clamp 220 to the rotation bunch 100.

A groove in which a tool is inserted may be formed at the head of the fastening member 230 in the embodiment and the groove may be formed in a polygonal shape.

Further, in the embodiment, threads may be formed at the lower portion of the fastening member 20 to be detachably thread-fastened to the fastening groove 221 of the second clamp 220.

Meanwhile, in the embodiment, a clamp unit 200a, as illustrated in FIG. 4, may include a plurality of insertion protrusions 240 formed on the inner sides of the first clamp 210 and the second clamp 220.

Like the clamp unit 200a of the embodiment, as a plurality of insertion protrusions 240 is provided and a plurality of rotation bunch grooves 110 is formed on the outer side of the rotation bunch 100 so that the insertion protrusions 240 are inserted at a predetermined depth, when a user turns the clamp unit 200a with a hand holding the handle body 210, the clamp unit 200a is prevented from sliding from the rotation bunch 100, and accordingly, idling of the clamp unit 200a can be prevented.

The handle 300, as illustrated in FIGS. 1 and 2, is rotatably coupled to a handle support arm 212, so it provides a handle place for a user.

In the embodiment, the handle 300, as illustrated in FIGS. 1 and 2, includes a handle body 310 having a plurality of support grooves 311 on the outer side and rotatably coupled to the handle support arm 212 and a fastening pin 320 rotatably coupling the handle body 310 to the handle support arm 212.

The plurality of support grooves 311 on the outer side of the handle body 310 of the handle 300 may be arranged with intervals corresponding to the gaps of fingers of a user, that is, the gap of fingers when a user holds the handle body 310 with a hand to apply force to the handle body 310.

Further, in the embodiment, a plurality of visual field hole 312 may be formed at predetermined distances in the height direction of the handle body 310, as illustrated in FIG. 1. According to the embodiment, it is possible to ensure a field of view for the front area through the plurality of visual field holes 312, even if the handle body 310 is vertically stood on the lens barrel 12 and blocks the field of view.

The fastening pin 320 of the handle 300, as illustrated in FIG. 1, may be fitted in holes formed in the handle body 310 and the handle support arm 212.

According to the embodiment, when, the handle 300 is not used, the handle 300 may be stowed in a folding position, as illustrated in FIG. 2.

FIG. 5 is a view illustrating use of an embodiment.

Use of the embodiment is briefly described, hereafter with reference to FIG. 5 and the figures described above.

First, according to the present invention, when the clamp unit 200 is coupled to the rotation bunch 100 rotatably disposed on the lens barrel 12 of the telescopic sight 10, the clamp unit 200 can be separated, as illustrated in FIG. 3, so the clamp unit 200 equipped with the handle 300 can be conveniently and rapidly mounted on the rotation bunch 100.

When the handle is turned clockwise or counterclockwise after the damp unit 200 equipped with the handle 300 is coupled to the rotation bunch 100, the magnification lens mounted in the telescopic sight 10 is horizontally moved, so the magnification of the telescopic sight 10 can be conveniently adjusted. For reference, an objective lens barrel 11 is disposed ahead of the lens barrel 12 and an eyepiece lens barrel 13 is disposed behind the lens barrel 12.

As described above, according to the embodiment, the rotation bunch for moving the magnification lens mounted in the telescopic sight is covered with the clamp unit and the clamp unit is detachably coupled to the rotation bunch, so they can be conveniently coupled and separated.

Further, the handle is mounted on the clamp unit turning integrally with the rotation bunch and a user turns the rotation bunch with a hand holding the handle, so it is possible to conveniently adjust the magnification of the telescopic sight.

It is apparent to those skilled in the art that the present invention is not limited to the embodiments described above and may be changed and modified in various ways without departing from the spirit and the scope of the present invention. Accordingly, the changed and modified examples should be construed as being included in claims of the present invention.

What is claimed is:

1. An improved variable magnification device, comprising:
a rotation bunch disposed around the outer side of lens barrel of a telescopic sight and moving a magnification lens mounted in the telescopic sight by turning around the outer side;
a clamp unit covering the outer side of the rotation bunch and turning with the rotation bunch; and
a handle disposed on the clamp unit and provided as a handle for a user to turn the rotation bunch,
wherein the clamp unit is detachably coupled to the rotation bunch

2. The improved variable magnification device of claim 1, wherein the clamp unit includes;
a first clamp covering a radius of the rotation bunch;
a second clamp covering the other radius of the rotation bunch; and
a fastening member detachably thread-fastening the first clamp and the second clamp to each other.

3. The improved variable magnification device of claim 2, wherein at least one insertion protrusion that is inserted in a rotation bunch groove of the rotation bunch is formed on at least one of the inner side of the first clamp and the inner side of the second clamp.

4. The improved variable magnification device of claim 1, wherein a handle support arm protruding toward the handle is formed at the clamp unit, and
the handle has:
a handle body having a plurality of support grooves on the outer side and rotatably coupled to the handle support arm; and
a fastening pin rotatably coupling the handle body to the handle support arm.

5. The improved variable magnification device of claim 4, wherein a plurality of visual field holes is formed in the height direction of the handle body.
